(19) United States
(12) Patent Application Publication
(10) Pub. No.: US 2010/0103765 A1
(43) Pub. Date: Apr. 29, 2010

(54) LIQUID INJECTOR FOR SILICON PRODUCTION

(76) Inventors: MARC D. HORNBOSTEL, Palo Alto, CA (US); Angel Sanjurjo, San Jose, CA (US); Kai-Hung Lau, Cupertino, CA (US); Gopala N. Krishnan, Sunnyvale, CA (US); Anoop Nagar, Palo Alto, CA (US); Lorenza Moro, San Carlos, CA (US); Jordi Perez Mariano, Menlo Park, CA (US); Xiaobing Xie, Foster City, CA (US); William C. Olson, San Jose, CA (US)

Correspondence Address: Wall & Tong, LLP;SRI INTERNATIONAL, 595 SHREWSBURY AVENUE, SHREWSBURY, NJ, 07702, US

(21) Appl. No.: 12/604,057

(22) Filed: Oct. 22, 2009

Related U.S. Application Data
(60) Provisional application No. 61/108,376, filed on Oct. 24, 2008.

(51) Int. Cl. B01F 5/04; B01F 15/06

(52) U.S. Cl. 366/145; 366/147

(57) ABSTRACT

The present invention relates generally to a liquid injector for silicon production. In one embodiment, the injector includes a tube having at least one opening at a first end of said tube, a moveable sealing means disposed inside the tube for sealing the at least one opening and a heating means coupled to the tube for controlling a temperature of a liquid exiting the tube through the at least one opening.

### CROSS REFERENCE TO RELATED APPLICATIONS

This application claims the benefit of U.S. Provisional Application No. 61/108,376, filed on Oct. 24, 2008, which is herein incorporated by reference in its entirety.

### FIELD OF THE INVENTION

The present invention relates generally to an apparatus used during the production of high purity metals, and more specifically to a liquid injector for silicon production.

### BACKGROUND OF THE INVENTION

One of the processes for producing high purity metals (e.g., silicon (Si)) for the electronics and solar cell industries reacts sodium (Na) with silicon tetrafluoride (SiF₄) to produce Si and sodium fluoride (NaF). One example of this process is described in U.S. Pat. No. 4,753,783 assigned to SRI International, which is incorporated herein by reference.

Na can be added either as a solid or as a liquid. The process can be performed in a batch mode, in which case when the reaction has run to completion, the reactant feeds to the reactor are turned off, the reactor is opened and the reaction product (e.g., pure Si and NaF) is removed. When Na is added as a liquid, it is injected into the reaction chamber from a tube in which the surface tension of the liquid sodium is used to prevent reactive gases from entering the tube. Before the reactor is opened, the liquid sodium is cooled and solidified on the nozzle tip forming a solid plug, preventing liquid Na from exiting the tube and air from entering the tube during product removal. However, the exposed surface of the sodium plug reacts with air to form sodium oxides or hydroxides. The solid oxides or hydroxides must be manually removed and the tube orifice cleaned before restarting the reactor. This leads to extended down times between reactor cycles.

In addition, it is occasionally necessary to pause the liquid sodium injection to correct upset conditions elsewhere in the process. Under these circumstances, the SiF₄ gas will slowly react with the exposed liquid sodium to produce a solid plug that will prevent restart of the production without opening the reactor and cleaning the orifice.

### SUMMARY OF THE INVENTION

The present invention is directed towards a liquid injector for silicon production. In one embodiment, the liquid injector for silicon production comprises a tube having at least one opening at a first end of said tube, a moveable plunger disposed inside said tube, said moveable plunger having a tip for forming a seal with said at least one opening at said first end of said tube and a temperature control element coupled to said tube.

In one embodiment, the liquid injector for silicon production comprises a tube having at least one opening at a first end of said tube and an annular volume along said first end, a moveable plunger disposed inside said tube, said moveable plunger having a tip for forming a seal with said at least one opening at said first end of said tube and a heat transfer fluid reservoir coupled to said tube for flowing a heat transfer fluid through said annular volume.

In one embodiment, the liquid injector for silicon production comprises a tube having at least one opening at a first end of said tube, a moveable sealing means disposed inside said tube for sealing said at least one opening and a heating means coupled to said tube for controlling a temperature of a liquid exiting said tube through said at least one opening.

### BRIEF DESCRIPTION OF THE DRAWINGS

The teaching of the present invention can be readily understood by considering the following detailed description in conjunction with the accompanying drawings, in which:

FIG. 1 illustrates a high level block diagram of the present invention;

FIG. 2 illustrates a first embodiment of a liquid injector; and

FIG. 3 illustrates a second embodiment of a liquid injector.

To facilitate understanding, identical reference numerals have been used, where possible, to designate identical elements that are common to the figures.

### DETAILED DESCRIPTION

The present invention provides a liquid injector for silicon production. For example, the liquid injector can be used to inject liquid sodium into a reactor for silicon production. Although the examples discussed below are in reference to liquid sodium, the present invention is not so limited. The liquid injector may be used to deliver any liquid compound into a reactor to provide many reactor cycles with minimal operator intervention.

As discussed above, before a reactor is opened during silicon production, liquid sodium that is injected into the reactor is cooled and solidifies on the nozzle tip forming a solid plug, preventing liquid sodium from exiting the tube and air from entering the tube during product removal. However, the exposed surface of the sodium plug reacts with air to form sodium oxides and hydroxides. The solid oxides or hydroxides must be manually removed and the tube orifice cleaned before restarting the reactor. This leads to extended down times between reactor cycles. However, the liquid injector discussed in the present application prevents solidification of the liquid sodium at the nozzle tip, while maintaining a required flow of the liquid and a temperature of the liquid sodium and of the reactor.

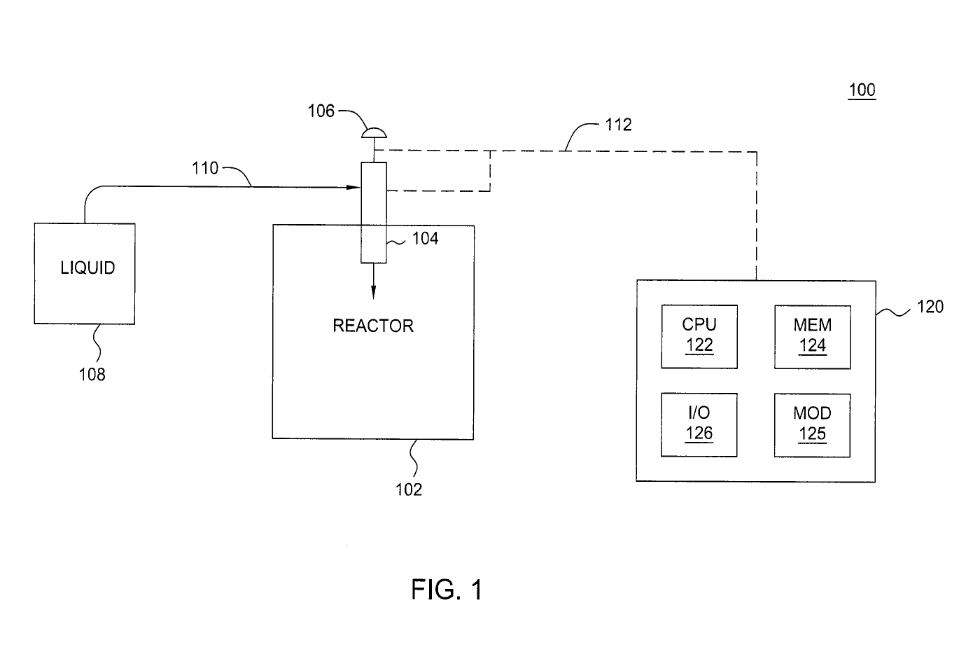

FIG. 1 illustrates a high level block diagram of a liquid injector 104 within the context of a system 100 in accordance with one embodiment of the present invention. For example, the system 100 include a reactor 102 and the liquid injector 104 coupled to the reactor 102. A valve 106 is coupled to the liquid injector 104. The valve 106 may be actuated by a mechanical system or assembly (e.g., a mechanical ball valve or gate valve), a pneumatic system or assembly (e.g., pneumatic valves operated by air), an electric system or assembly (e.g. a solenoid valve), a hydraulic system or assembly (e.g., a hydraulic valve actuated by the flow of a fluid) or any combination thereof. For example, the valve 106 may be a mechanical valve operated by a person or the valve 106 may be a solenoid valve or pneumatic valve automatically actuated by an electrical signal or an air line.

A liquid 108 may be provided to the reactor 102 using the liquid injector 104 via line 110. In one embodiment, the liquid 108 may be liquid sodium used for the production of silicon. In one embodiment, the liquid 108 may be contained in a reservoir or a storage tank. In another embodiment, the liquid 108 may be fed from another source, for example another reactor within a process.

The system 100 may also include a controller 120 coupled to the valve 106 and the liquid injector 104 via a control signal line 112. The controller 120 may be a general-purpose computer suitable for use in performing the functions described herein.

The controller 120 may comprise a processor element 122 (e.g., a CPU), a memory 124, e.g., random access memory (RAM) and/or read only memory (ROM), a module 125 for providing a pulse rate and a temperature control algorithm, as discussed below, and various input/output devices 126 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the controller 120 can be implemented in software and/or in a combination of software and hardware, e.g., using application specific integrated circuits (ASIC), a general purpose computer or any other hardware equivalents. In one embodiment, the present module 125 for providing a pulse rate and a temperature control algorithm can be loaded into memory 124 and executed by processor 122 to implement the functions as discussed below. As such, the present module 125 for providing a pulse rate and a temperature control algorithm can be stored on a computer readable storage medium, e.g., RAM memory, magnetic or optical drive or diskette and the like.

In one embodiment, the controller 120 is used to control the liquid injector 104 at a predefined pulse rate. For example, the controller 120 may automatically actuate the valve 106 by sending a control signal to the valve 106 or to an air line that actuates the valve 106 to open and close the liquid injector 104 at the predefined pulse rate. In addition, the controller 120 is communication with various sensors within the liquid injector 104 to control a temperature of the liquid exiting the liquid injector 104, as discussed below.

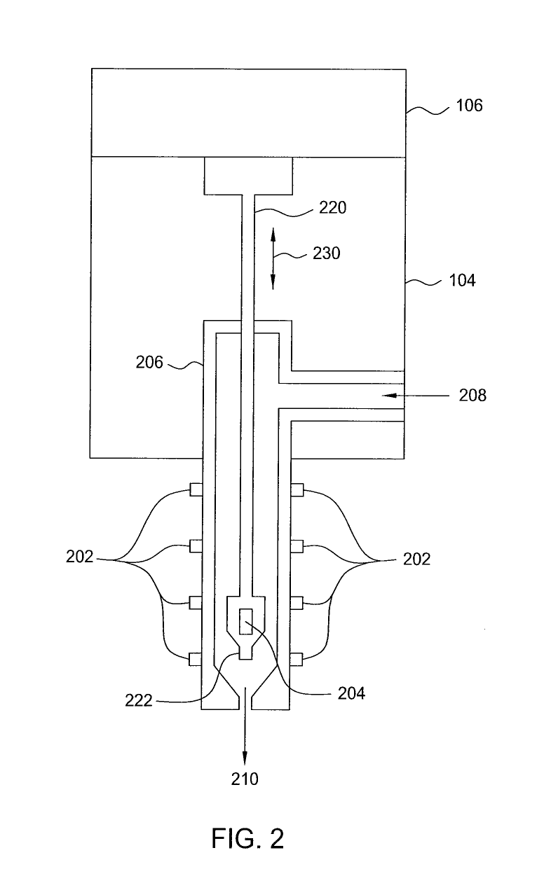

FIG. 2 illustrates a more detailed cross sectional view of one embodiment of the liquid injector 104. In one embodiment, the liquid injector 104 includes a tube 206 and a moveable plunger 220 (hereinafter also referred to as a plunger 220) coupled to the tube 206. The tube 206 has an interior volume. In one embodiment, the plunger 220 moves axially up and down in a direction relative to a bottom and a top of the tube 206 as indicated by line 230. The plunger 220 is coupled to the tube 206 in the interior volume of the tube 206. The plunger 220 is also coupled to a valve 106.

In one embodiment, the tube 206 and the plunger 220 are fabricated from metal, e.g., stainless steel. In one embodiment, the plunger 220 may be fabricated from any material that is not wetted by the liquid, e.g., liquid sodium or react with process gases. For example, when the liquid is liquid sodium and the process gases include silicon tetrafluoride (SiF₄), the plunger 220 may be made of a material that does not react with the liquid sodium or the SiF₄.

The tube 206 includes an inlet 208 and an outlet 210. The outlet has a diameter that is sufficient to provide a liquid in a stream. Said another way, the outlet should not have a diameter that causes “spraying” of the liquid.

In addition, the outlet 210 has a shape that is substantially similar to a shape of a tip 222 of the plunger 220. As a result, when the tip 222 of the plunger 220 is mated with the outlet 210, a gas tight seal is formed. In one embodiment, “gas tight” is defined as preventing any air or process gas from entering the tube 206. Accordingly, none of the liquid within the tube 206 is reacted, thereby, preventing solidification of the liquid within the tube 206.

In addition, the outlet 210 is located on one end of the tube 206. That is, the outlet 210 is located as close to a bottom edge or perimeter of the tube 206 and not towards the center of the tube 206 as found in valves. As a result, when the tip 222 of the plunger 220 is mated with the outlet 210, no open volume remains in the tube 206. In other words, a bottom of the tube 206 and a bottom of the tip 222 of the plunger 220 lie on and share a single plane. Said another way, the bottom of the tube 206 and the bottom of the tip 222 of the plunger 220 are flush.

Moreover, as the tip 222 is pushed into the outlet 210, the tip 222 is designed to discharge any residual liquid out of the tube 206. In other words, the tip 222 is designed to “squeegee” liquid remaining in the outlet out of the tube 206. This prevents residual liquid being left within the tube near the outlet 210 and provides another level of protection against having any liquid solidify by reacting with the air and process gases, thereby, plugging the liquid injector 104.

The liquid injector 104 also includes a temperature sensor 204. In one embodiment, the temperature sensor 204 is located in the tip 222 of the plunger 220. However, it should be noted that the temperature sensor 204 may be located anywhere on or within the liquid injector 104 for measuring the liquid temperature exiting the liquid injector 104. The temperature sensor 204 may be any type of temperature sensor, for example, a thermocouple. In addition, the liquid injector 104 may include a temperature control element 202 (e.g. a coil) around the tube 206. The temperature control element 202 may be used to heat or cool the liquid. When only heating is used, the temperature control element 202 may be heating coils that use any type of heating mechanism, e.g., radio frequency (RF) induction, resistive heating, flowing heated fluid through the temperature control element 202, and the like. When heating and cooling is used, the temperature control element 202 may be, for example, a Peltier device or coils with a heat exchanging fluid that can heat and cool. The temperature sensor 204 and the temperature control element 202 are in communication with the controller 120 illustrated in FIG. 1.

The combination of the temperature sensor 204 and the temperature control element 202 are used to control a temperature of the liquid exiting the liquid injector 104. For example, the temperature of the liquid is controlled to control viscosity of the liquid to allow the liquid to flow freely. In addition, the liquid temperature is controlled to prevent the liquid from reacting immediately and self igniting.

In one embodiment, the temperature sensor 204 may send temperature readings of the liquid at the outlet 210 to the controller 120. A maximum temperature threshold and a minimum temperature threshold can be predefined. If the temperature readings of the liquid are below a minimum temperature, the controller 120 may signal the temperature control element 202 to heat the liquid. If the temperature readings of the liquid are above a maximum temperature threshold, the controller 120 may signal the temperature control element 202 to cool the liquid.

It should be noted that the temperature control element 202 may be used also to maintain the liquid temperature within a predefined range, e.g., between the minimum temperature threshold and the maximum temperature threshold. For example, the controller 120 may cycle between heating and cooling to maintain the temperature within the predefined range.

In FIG. 2, the liquid injector 104 is illustrated in an “open” position. As discussed above, the valve 106 is actuated to move the plunger 220 within the tube 206 to close the tube 206. As discussed above, the valve 106 may be actuated by a mechanical system or assembly (e.g., a mechanical ball valve or gate valve), a pneumatic system or assembly (e.g., pneumatic valves operated by air), an electric system or assembly (e.g. a solenoid valve), a hydraulic system or assembly (e.g., a hydraulic valve actuated by the flow of a fluid) or any combination thereof. The valve 106 can be actuated periodically to move the plunger 220 up and down or pulsate the plunger 220. The pulse rate of the plunger 220 can be used to control an average velocity of the liquid exiting the liquid injector 104 and a temperature of the reactor 102.

The rate of pulsing can be controlled manually or automatically by a controller 120, as shown in FIG. 1. In one embodiment, the pulse rate is used to control the average feed rate of the liquid into the reactor. By controlling the average feed rate of the liquid, the temperature of the reactor can also be controlled.

In some processes, for example injecting liquid sodium during the production of silicon, it is desirable to have the liquid sodium react with process gases towards a bottom of a reactor. This also helps to control the temperature of the reactor. Pulsing the plunger 220 at a predefined pulse rate also controls an average velocity of the liquid exiting the liquid injector 104.

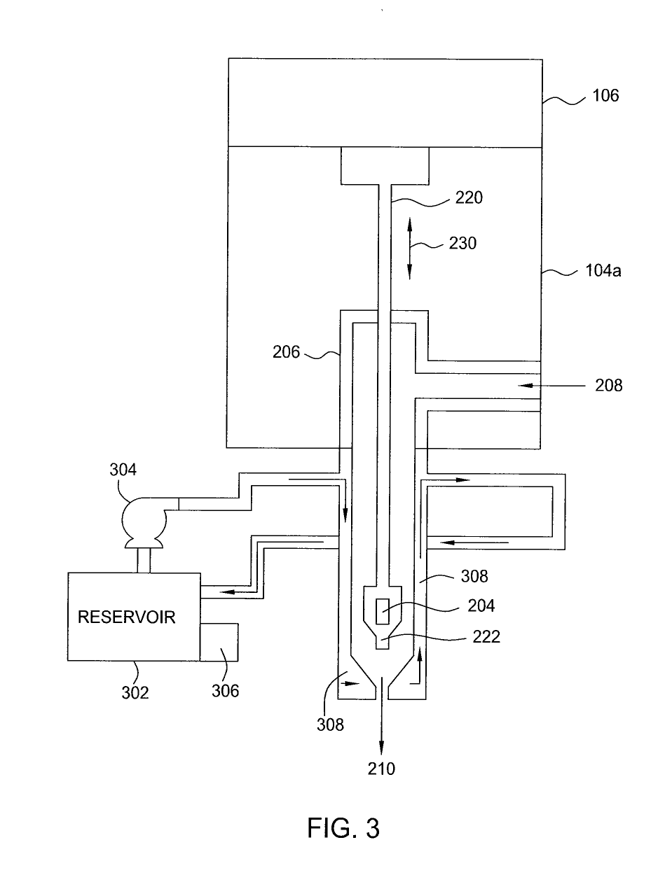

FIG. 3 illustrates a more detailed cross sectional view of another embodiment of the liquid injector 104a. The liquid injector 104a illustrated in FIG. 3 is similar to the liquid injector 104 illustrated in FIG. 2 in many respects. For example, the liquid injector 104a illustrated in FIG. 3 includes a tube 206 and a moveable plunger 220 coupled to the tube 206. The plunger 220 moves axially up and down in a direction relative to a bottom and a top of the tube 206 as indicated by line 230. The plunger 220 is coupled to the inside of the tube 206 and a valve 106.

In one embodiment, the tube 206 and the plunger 220 are fabricated from metal, e.g., stainless steel. In one embodiment, the plunger 220 may be fabricated from any material that does not wet the liquid, e.g., liquid sodium or react with process gases. For example, when the liquid is liquid sodium and the process gases include silicon tetrafluoride (SiF₄), the plunger 220 may be made of a material that does not react with the liquid sodium or the SiF₄.

The tube 206 includes an inlet 208 and an outlet 210. The outlet has a diameter that is sufficient to provide a liquid in a stream. Said another way, the outlet should not have a diameter that causes “spraying” of the liquid. In addition, the outlet 210 has a shape that is substantially similar to a shape of a tip 222 of the plunger 220. As a result, when the tip 222 of the plunger 220 is mated with the outlet 210, a gas tight seal is formed. In one embodiment, “gas tight” is defined as preventing any air or process gas from entering the tube 206. Accordingly, none of the liquid within the tube 206 is reacted, thereby, preventing solidification of the liquid within the tube 206.

In addition, the outlet 210 is located on one end of the tube 206. That is, the outlet 210 is located as close to a bottom edge or perimeter of the tube 206 and not towards the center of the tube 206 as found in valves. As a result, when the tip 222 of the plunger 220 is mated with the outlet 210, no open volume remains in the tube 206. In other words, a bottom of the tube 206 and a bottom of the tip 222 of the plunger 220 lie on and share a single plane. Said another way, the bottom of the tube 206 and the bottom of the tip 222 of the plunger 220 are flush.

Moreover, as the tip 222 is pushed into the outlet 210, the tip 222 is designed to discharge any residual liquid out of the tube 206. In other words, the tip 222 is designed to “squeegee” liquid remaining in the outlet out of the tube 206. This prevents residual liquid being left within the tube near the outlet 210 and provides another level of protection against having any liquid solidify by reacting with the air and process gases, thereby, plugging the liquid injector 104.

The liquid injector 104 also includes a temperature sensor 204. In one embodiment, the temperature sensor 204 is located in the tip 222 of the plunger 220. The temperature sensor 204 may be any type of temperature sensor, for example, a thermocouple.

The liquid injector 104a illustrated in FIG. 3 differs from the liquid injector 104 illustrated in FIG. 2 in the way the temperature of the liquid is controlled. The tube 206 of liquid injector 104a illustrated in FIG. 3 comprises an annular volume 308 along one end of the tube 206. In addition, a reservoir 302 of a heat transfer fluid and a pump 304 is coupled to the annular volume 308 of the tube 206. The pump 304 is used to pump the heat transfer fluid from the reservoir 302 through the annular volume 308 of the tube 206. The pump 304 may be any type of pump, for example, a centrifugal pump, a diaphragm pump, an impeller pump, a rotary pump, an air operated pump, and the like. The heat transfer fluid may be any hydrocarbon based or silicone based heat transfer fluid or oil that is commercially available.

In addition, a temperature control element 306 is coupled to the reservoir 302. In one embodiment, the pump 304, the temperature control element 306 and the temperature sensor 204 are in communication with the controller 120.

Although only one reservoir 302 is illustrated, it should be noted that multiple reservoirs 302 of heat transfer fluid may be used. For example, one reservoir may be coupled to a heating element and one reservoir may be coupled to a cooling element. A switch or three way valve may be coupled to the pump 304 and both reservoirs. As a result, either heated heat transfer fluid to heat the liquid or cooled heat transfer liquid to cool the liquid may be pumped through the annular volume 308.

In one embodiment, the temperature sensor 204 may send temperature readings of the liquid at the outlet 210 to the controller 120. A maximum temperature threshold and a minimum temperature threshold can be predefined. If the temperature readings of the liquid are below a minimum temperature, the controller 120 may signal the temperature control element 306 to heat the reservoir 302 and signal the pump 304 to begin pumping the heated heat transfer fluid through the annular volume 308. If the temperature readings of the liquid are above a maximum temperature threshold, the controller 120 may signal the temperature control element 306 to cool the reservoir 302 and signal the pump 304 to begin pumping the cooled heat transfer fluid through the annular volume 308.

It should be noted that the heat transfer fluid may be used also to maintain the liquid temperature within a predefined range, e.g., between the minimum temperature threshold and the maximum temperature threshold. For example, the controller 120 may cycle between heating and cooling of the heat transfer fluid to maintain the temperature within the predefined range.

While various embodiments have been described above, it should be understood that they have been presented by way of example only, and should not be considered limiting. Thus, the breadth and scope of a preferred embodiment should not be limited by any of the above-described exemplary embodiments, but should be defined only in accordance with the following claims and their equivalents.

What is claimed is:

1. A liquid injector for use with a reactor, comprising:
a tube having at least one opening at a first end of said tube;
a moveable plunger disposed inside said tube, said moveable plunger having a tip for forming a seal with said at least one opening at said first end of said tube; and
a temperature control element coupled to said tube.

2. The liquid injector of claim 1, wherein said tip of said moveable plunger and said at least one opening have a substantially same shape.

3. The liquid injector of claim 1, wherein said tube and said moveable plunger comprise a metal.

4. The liquid injector of claim 1, wherein said moveable plunger is automatically actuated via at least one of: a mechanical means, a pneumatic means, a hydraulic means or an electric means.

5. The liquid injector of claim 1, further comprising:
a controller coupled to said liquid injector for controlling said moveable plunger in accordance with a predefined pulse rate and operation of said temperature control element.

6. The liquid injector of claim 5, further comprising:
a temperature sensor coupled to said moveable plunger, wherein said temperature sensor is in communication with said controller for controlling said temperature control element.

7. The liquid injector of claim 5, wherein said predefined pulse rate is in accordance with a desired rate of feed into said reactor and a desired temperature of said reactor.

8. The liquid injector of claim 5, wherein said predefined pulse rate is determined in accordance with a predetermined average velocity needed to provide a liquid to a bottom of said reactor.

9. A liquid injector for use with a reactor, comprising:
a tube having at least one opening at a first end of said tube and an annular volume along said first end;
a moveable plunger disposed inside said tube, said moveable plunger having a tip for forming a seal with said at least one opening at said first end of said tube; and
a heat transfer fluid reservoir coupled to said tube for flowing a heat transfer fluid through said annular volume.

10. The liquid injector of claim 9, wherein said tip of said moveable plunger and said at least one opening have a substantially same shape.

11. The liquid injector of claim 9, wherein said tube and said moveable plunger comprise a metal.

12. The liquid injector of claim 9, wherein said moveable plunger is automatically actuated via at least one of: a mechanical means, a pneumatic means, a hydraulic means or an electric means.

13. The liquid injector of claim 9, further comprising:
a controller coupled to said liquid injector for controlling said moveable plunger in accordance with a predefined pulse rate and an operation of said heat transfer fluid reservoir.

14. The liquid injector of claim 13, further comprising:
a temperature sensor coupled to said moveable plunger, wherein said temperature sensor is in communication with said controller for controlling a flow of said heat transfer fluid.

15. The liquid injector of claim 13, wherein said predefined pulse rate is in accordance with a desired amount of a liquid introduced into said reactor and a desired temperature of said reactor.

16. The liquid injector of claim 13, wherein said predefined pulse rate is determined in accordance with a predetermined average velocity needed to provide a liquid to a bottom of said reactor.

17. The liquid injector of claim 9, further comprising:
a pump coupled to said heat transfer fluid reservoir; and
a temperature control element coupled to said heat transfer fluid reservoir.

18. The liquid injector of claim 9, wherein said heat transfer fluid flows through said annular volume.

19. The liquid injector of claim 9, wherein aid heat transfer fluid comprises at least one of: a hydrocarbon based fluid or a silicone based fluid.

20. A liquid injector for use with a reactor, comprising:
a tube having at least one opening at a first end of said tube;
a moveable sealing means disposed inside said tube for sealing said at least one opening; and
a heating means coupled to said tube for controlling a temperature of a liquid exiting said tube through said at least one opening.
